(19) United States
(12) Patent Application Publication
(10) Pub. No.: US 2009/0123068 A1
(43) Pub. Date: May 14, 2009

(54) METHOD FOR ADAPTIVELY ADJUSTING IMAGE AND IMAGE PROCESSING APPARATUS USING THE SAME

(75) Inventors: Ling-Hsiu Huang, Tainan County (TW); Shing-Chia Chen, Tainan County (TW)

Correspondence Address: J C PATENTS, INC., 4 VENTURE, SUITE 250, IRVINE, CA, 92618, US

(73) Assignee: HIMAX TECHNOLOGIES LIMITED, Tainan County (TW)

(21) Appl. No.: 11/939,268

(22) Filed: Nov. 13, 2007

(51) Int. Cl. G06K 9/00; G06K 9/40

(52) U.S. Cl. 382/169; 382/274

(57) ABSTRACT

A method for adaptively adjusting image and an image processing apparatus using the same are provided. The apparatus includes a statistics apparatus and an image adjustment apparatus. The statistics apparatus receives a plurality of pixels in an image to generate a gray-level distribution of the pixels and searches a specific gray-level according to the gray-level distribution, in which a specific percentage of pixels have gray-levels smaller than the specific gray-level. The image adjustment apparatus adjusts the image according to the specific gray-level.

### BACKGROUND OF THE INVENTION

1. Field of the Invention

The present invention relates to image processing. More particularly, the present invention relates to a method and apparatus for adaptively adjusting an image.

2. Description of Related Art

Image processing modifies various image attributes, such as color, brightness, or to combine photographs. For example, some functions of the image processing, e.g., the modification of the brightness and the contrast, are used to quickly change a photograph of a sunny day to a photograph of a rainy day. The modification of the image can further be processed by selection, cut and paste.

In order to improve the display quality of the flat panel display, the image can be dynamically adjusted, for example, according to the brightness of the image. For a dark image, the adjustments are made to increase the contrast, reduce the brightness, and reduce the light source. For a bright image, the adjustments are made to reduce the contrast, increase the brightness, and increase the light source.

The image mean brightness is a usually used judgment index for some image processing. FIG. 1 is a block diagram of a conventional image processing apparatus. Referring to FIG. 1, the image processing apparatus 100 includes a brightness mean value detector 101, a contrast controller 102, and a brightness controller 103. First, the brightness mean value detector 101 receives an image to generate a mean brightness value of the image. Next, the contrast controller 102 and the brightness controller 103 are used to respectively adjust the contrast and the brightness of the image by using the obtained brightness mean value as a judgment index. Further, the light source is correspondingly adjusted, thereby improving the display quality of the image.

However, in many cases, it is not sufficient to adjust the images merely by the mean brightness values. For example, for two images as shown in FIG. 2A (the brightness difference across the image is relatively small) and FIG. 2B (the brightness difference across the image is relatively large), the mean brightness values of the two images are the same, 55 for example. However, if the same adjustment is performed respectively to the images, the results would not be good enough for both the images.

### SUMMARY OF THE INVENTION

Accordingly, the present invention is directed to providing a method for adaptively adjusting an image and an image processing apparatus using the same, which are capable of generating and analyzing a gray-level distribution of image pixels, so as to adjust the image to the optimal quality according to the gray-level distribution.

The present invention provides a method for adaptively adjusting the image. The method at least includes providing an image having a plurality of pixels, generating a gray-level distribution of the pixels, and searching a specific gray-level according to the gray-level distribution. A specific percentage of the pixels have gray-levels smaller than the specific gray-level. Next, the image is further adjusted according to the specific gray-level.

In the method according to the preferred embodiment of the present invention, wherein the step of generating the gray-level distribution of the pixels includes counting the number of the pixels of each gray-level. In another embodiment of the present invention, the specific percentage is approximately 90%. In still another embodiment of the present invention, the step of adjusting the image includes applying the brightness gain to the image and adjusting the contrast of the image according to the specific gray-level.

In the method according to the preferred embodiment of the present invention, the image is displayed on a screen having a light source, and the step of adjusting the image includes adjusting the brightness of the light source and adjusting the contrast of the image according to the specific gray-level. In another embodiment of the present invention, the step of adjusting the brightness of the light source includes determining the brightness of the light source through looking up a table by using the specific gray-level as an index. In still another embodiment of the present invention, the step of adjusting the contrast of the image includes determining the contrast of the image through looking up a table by using the specific gray-level as an index.

The present invention further provides an image processing apparatus. The apparatus includes a statistics apparatus and an image adjustment apparatus. The statistics apparatus is used to receive a plurality of pixels of an image, and generate a gray-level distribution of the pixels, and search a specific gray-level according to the gray-level distribution. The image adjustment apparatus is used to adjust the image according to the specific gray-level, wherein a specific percentage of the pixels have gray-levels smaller than the specific gray-level.

In the apparatus according to the preferred embodiment of the present invention, the image adjustment apparatus includes a brightness adjustment apparatus and a contrast adjustment apparatus. The brightness adjustment apparatus and the contrast adjustment apparatus respectively give a brightness gain and a contrast adjustment parameter to the image according to the specific gray-level. In another embodiment of the present invention, the image is displayed on a screen having a light source, and the image adjustment apparatus includes a brightness adjustment apparatus. The brightness adjustment apparatus adjusts the brightness of the light source according to the specific gray-level. In still another embodiment of the present invention, the brightness adjustment apparatus includes a gray-level/brightness table, and the brightness of the light source is determined through looking up the table by using the specific gray-level as an index.

In the apparatus according to the preferred embodiment of the present invention, the contrast adjustment apparatus includes a gray-level/contrast table, and the contrast of the image is determined through looking up the table by using the specific gray-level as an index. In another embodiment of the present invention, the statistics apparatus is further used for counting the number of the pixels of each gray-level. In still another embodiment of the present invention, the specific percentage is substantially approximately 90%.

In the present invention, the statistics apparatus generates the gray-level distribution of the image pixels, and searches a specific gray-level according to the gray-level distribution of the image pixels, so as to further adjust at least the brightness and the contrast parameter of the image according to the obtained specific gray-level, thereby making the image have the optical quality.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a conventional image processing apparatus.

FIG. 2A is a schematic view of an image (the brightness difference is relatively small).

FIG. 2B is a schematic view of another image (the brightness difference is relatively large).

FIG. 3 is a flow chart of a method for adaptively adjusting the image according to an embodiment of the present invention.

FIG. 4 is a block diagram of an image processing apparatus according to the embodiment of the present invention.

FIG. 5A is a gray-level distribution diagram of the image pixels of FIG. 2A.

FIG. 5B is a gray-level distribution diagram of the image pixels of FIG. 2B.

FIG. 6A is a table of the gray-level/brightness of the image adjustment.

FIG. 6B is a table of the gray-level/contrast of the image adjustment.

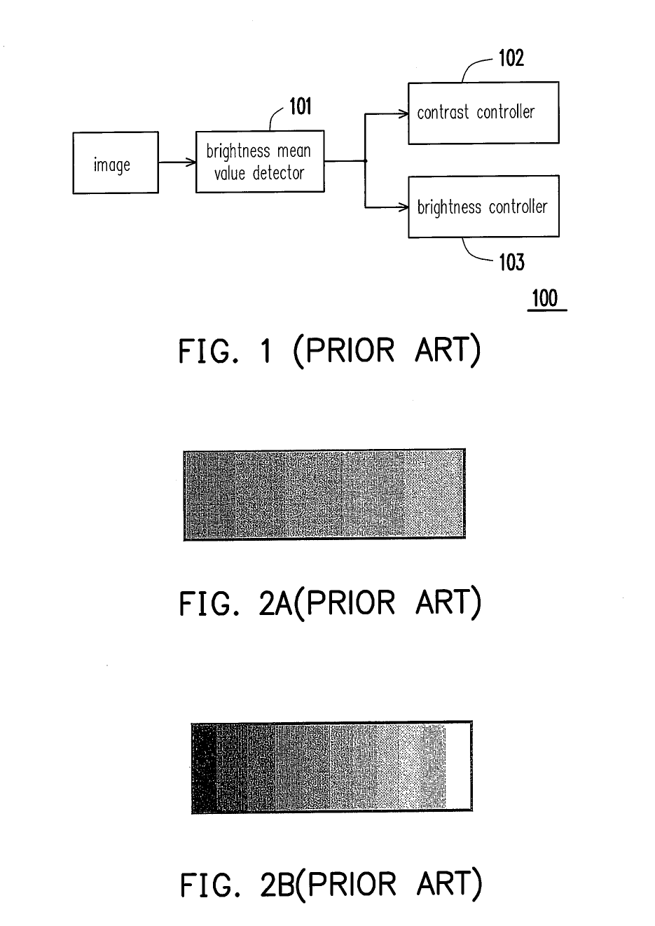

### DESCRIPTION OF EMBODIMENTS

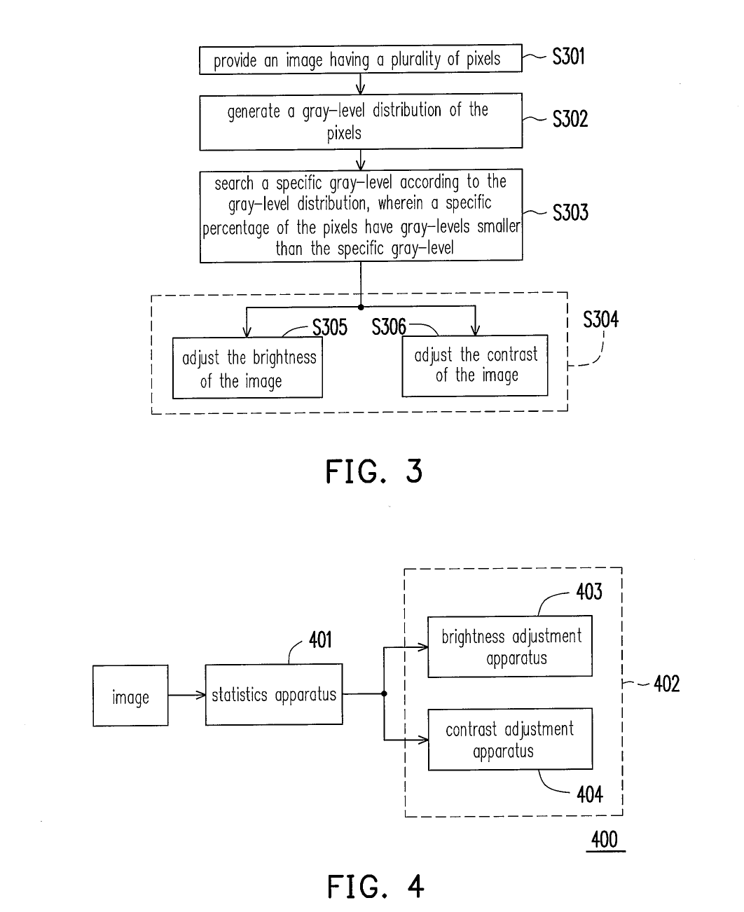

FIG. 3 is a flow chart of a method for adaptively adjusting an image according to an embodiment of the present invention. FIG. 4 is a block diagram of an image processing apparatus according to the embodiment of the present invention. Referring to FIGS. 3 and 4, the image processing apparatus 400 includes a statistics apparatus 401 and an image adjustment apparatus 402. The image adjustment apparatus 402 includes a brightness adjustment apparatus 403 and a contrast adjustment apparatus 404. First, an image having a plurality of pixels is provided (step S301). The image is, for example, a digital image output by a digital camera or a digital video camera, a digital image or a video output by a computer, or the like.

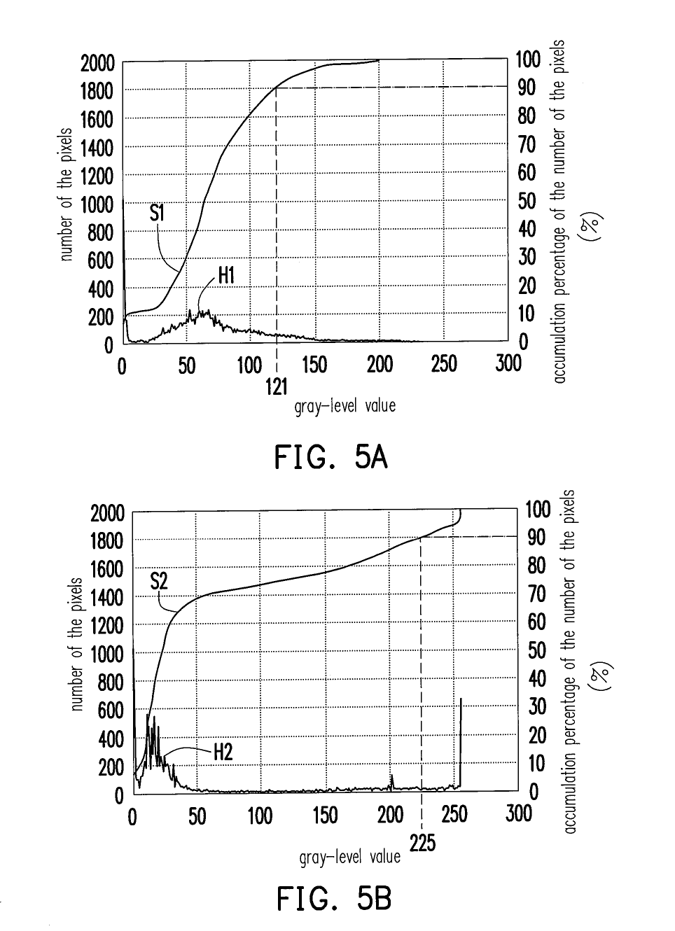

Next, the image is transmitted to the statistics apparatus 401 to generate a histogram that includes the statistics of the gray-level distribution of the image pixels (step S302). In the step S302, the statistics apparatus 401 performs a pixel-gray-level analysis on the whole image, for 256 gray-levels, to found out how many pixels each gray-level has. For example, the number of the image pixels with a gray-level value of 0 is 100. The number of the image pixels with a gray-level value of 1 is 20, the number of the image pixels with a gray-level value of 2 is 10, and so on. In the statistics generating process, the number of the pixels in each gray-level is record, and it is shown as a distribution curve H1, referred to a gray-level histogram, as shown FIG. 5A. Next, the integration of the distribution curve H1 is calculated to generate an accumulation curve S1.

Next, a specific gray-level is found out according to the accumulation curve S1 of the gray-level distribution, and the gray-levels of a specific percentage of pixels among the image are smaller than the specific gray-level (step S303). In order to make this embodiment be clearer, here it is assumed that the specific percentage is 90%. Therefore, the specific gray-level actually represents that 90% pixels among the image have gray-levels smaller than the specific gray-level. The specific gray-level obtained from the image in FIG. 2A will be smaller than that from the image in FIG. 2B, because the gray-level distribution of the image in FIG. 2B is extremely variant and the gray-level distribution of the image in FIG. 2A is relatively centralized.

Finally, the image is adjusted according to the specific gray-level (step S304). The statistics apparatus 401 respectively transmits the specific gray-level to the brightness adjustment apparatus 403 and to the contrast adjustment apparatus 404. The brightness adjustment apparatus 403 may apply a brightness gain to the image according to the specific gray-level, and may further adjust the brightness of the light source accordingly (step S305). The contrast adjustment apparatus 404 applies a contrast adjustment parameter according to the specific gray-level to adjust the contrast of the image (step S306). In addition to the contrast and the brightness, the image adjustment apparatus 402 can adjust other image attributes, and it is not described here.

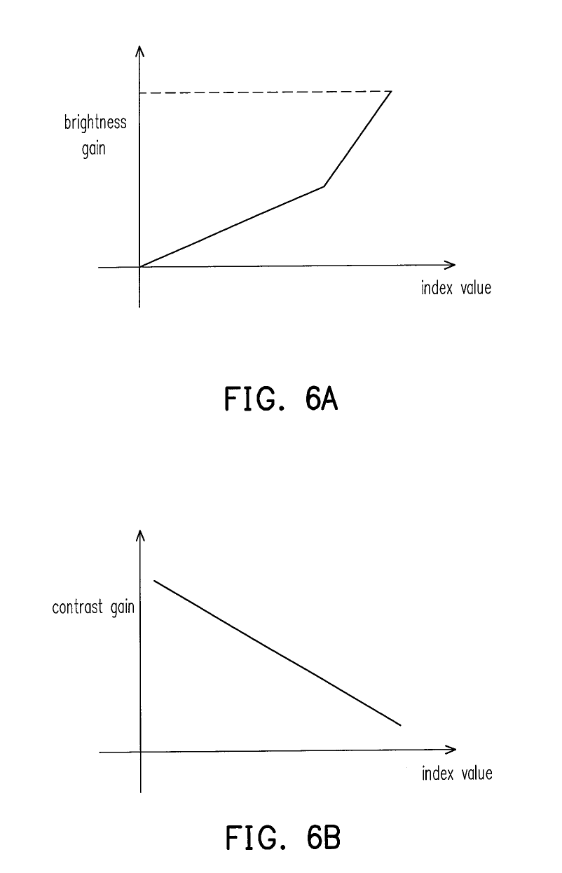

The brightness adjustment apparatus 403 determines the magnitude of the brightness gain by looking up a gray-level/brightness table according to the specific gray-level as a judgment index for applying the brightness gain to the image and adjusting the brightness of the light source, such that the displayed image is optimized. For example, in FIG. 6A, when the judgment index is relatively large, the required brightness gain is relatively large; when the judgment index is relatively small, the required brightness gain is relatively small.

The contrast adjustment apparatus 404 determines the magnitude of the contrast adjustment parameter by looking up a gray-level/contrast table according to the specific gray-level as a judgment index. For example, as shown in FIG. 6B, when the judgment index is relatively small, the contrast adjustment parameter is relatively large; when the judgment index is relatively large, the contrast adjustment parameter is relatively small.

As described in the conventional art, the method of using the mean brightness value as the judgment index can not properly adjust the image, thus easily resulting in the unsuitable processed image. In the embodiment of the present invention, the method of obtaining the judgment index according to the gray-level histogram results in suitable processed image.

Taking the images with the same mean brightness value (as shown in FIGS. 2A and 2B) as an example, the corresponding histograms are shown in FIGS. 5A and 5B generated by the statistics apparatus 401. The horizontal axis of FIGS. 5A and 5B is the gray-level value (0-255), the left vertical axis is the number of the pixels, and the right vertical axis is the accumulation percentage of the number of the pixels. In FIGS. 5A and 5B, at the accumulation percentage of 90%, the corresponding specific gray-level values are respectively 121 and 225, which is used as the judgment index for the images in FIGS. 2A and 2B.

Further, the contrast adjustment value/brightness adjustment value of the images shown in FIGS. 2A and 2B are determined by the judgment index values. If the adjustments are made according to the mean brightness value of the image as in the conventional way, the image of FIG. 2B is unsuitably adjusted. On the contrary, if the adjustments are made according to the embodiment of the present invention, the images of FIGS. 2A and 2B are both adjusted properly. Therefore, the embodiment implemented according to the spirit of the present invention can well discern the images to perform the suitable adjustment on the images respectively.

It is noted that although in the above embodiment, a possible type of the image processing apparatus is described, but those of ordinary skill in the art should know that the design manners of various manufacturers on the statistics apparatus 401 and the image adjustment apparatus 402 are diverse, so the application of the present invention is not limited to the possible type. In another word, as long as the statistics apparatus 401 can make analysis and statistics of the gray-level distribution of the images, and can find out a specific gray-level according to the gray-level distribution, so as to adjust the image and improve the image quality, the spirit of the present invention is satisfied.

In view of the above, in the present invention, the statistics apparatus is adopted to make statistics and analysis of the gray-level distribution, and to adjust the brightness and the contrast of the image according to the gray-level distribution of the pixels, such that the image has an optimal display quality. Therefore, the present invention can effectively analyze the bright and dark components of various images, and can adjust the images to the optimal quality according to the gray-level distribution of each image.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for adaptively adjusting an image, comprising:
providing an image having a plurality of pixels;
generating a gray-level distribution of the pixels;
searching a specific gray-level according to the gray-level distribution, wherein a specific percentage of the pixels have gray-levels smaller than the specific gray-level; and
adjusting the image according to the specific gray-level.

2. The method for adaptively adjusting an image as claimed in claim 1, wherein the step of generating the gray-level distribution of the pixels comprises:
counting the number of the pixels of each gray-level.

3. The method for adaptively adjusting an image as claimed in claim 1, wherein the specific percentage is approximately 90%.

4. The method for adaptively adjusting an image as claimed in claim 1, wherein the step of adjusting the image comprises applying a brightness gain to the image.

5. The method for adaptively adjusting an image as claimed in claim 1, wherein the step of adjusting the image comprises adjusting a contrast of the image according to the specific gray-level.

6. The method for adaptively adjusting an image as claimed in claim 1, wherein the image is displayed on a screen having a light source, and the step of adjusting the image comprises adjusting the brightness of the light source according to the specific gray-level.

7. The method for adaptively adjusting the image as claimed in claim 6, wherein the step of adjusting the brightness of the light source comprises determining the brightness of the light source through looking up a table by using the specific gray-level as an index.

8. The method for adaptively adjusting an image as claimed in claim 6, wherein the step of adjusting the image further comprises adjusting the contrast of the image according to the specific gray-level.

9. The method for adaptively adjusting an image as claimed in claim 8, wherein the step of adjusting the contrast of the image comprises determining the contrast of the image through looking up a table by using the specific gray-level as an index.

10. An image processing apparatus, comprising:
a statistics apparatus for receiving a plurality of pixels of an image, generating a gray-level distribution of the pixels, and searching a specific gray-level according to the gray-level distribution; and
an image adjustment apparatus for adjusting the image according to the specific gray-level;
wherein a specific percentage of pixels have gray-levels smaller than the specific gray-level.

11. The image processing apparatus as claimed in claim 10, wherein the image adjustment apparatus comprises:
a brightness adjustment apparatus for applying a brightness gain to the image according to the specific gray-level.

12. The image processing apparatus as claimed in claim 10, wherein the image is displayed on a screen having a light source, and the image adjustment apparatus comprises:
a brightness adjustment apparatus for adjusting the brightness of the light source
according to the specific gray-level.

13. The image processing apparatus as claimed in claim 12, wherein the brightness adjustment apparatus comprises:
a gray-level/brightness table, for determining the brightness of the light source through looking up the gray-level/brightness table by using the specific gray-level as an index.

14. The image processing apparatus as claimed in claim 10, wherein the image adjustment apparatus comprises:
a contrast adjustment apparatus, applying a contrast adjustment parameter to the image according to the specific gray-level.

15. The image processing apparatus as claimed in claim 14, wherein the contrast adjustment apparatus comprises:
a gray-level/contrast table, for determining the contrast of the image through looking up the table by using the specific gray-level as an index.

16. The image processing apparatus as claimed in claim 10, wherein the statistics apparatus is further used for counting the number of the pixels of each gray-level.

17. The image processing apparatus as claimed in claim 10, wherein the specific percentage is substantially approximately 90%.
